(19) United States
(12) Patent Application Publication
(10) Pub. No.: US 2005/0162992 A1
(43) Pub. Date: Jul. 28, 2005

(54) Information access control method, access control program, and external recording medium

(75) Inventors: Kazuo Nakashima, Kawasaki (JP); Masahiro Nakada, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/085,394

(22) Filed: Mar. 21, 2005

Related U.S. Application Data
(63) Continuation of application No. PCT/JP03/03216, filed on Mar. 18, 2003.

(51) Int. Cl. G11B 7/085

(52) U.S. Cl. 369/30.29; 369/30.27

(57) ABSTRACT

An information access control method is presented by which access to certain specified information on an information system is restricted by means of the authentication of external recording media. The information access control method that accesses information data on an information system by using an external recording medium includes the steps of, wherein system user information is recorded onto the external recording medium, and the corresponding user information is also registered in advance on the information system, comparing the system user information sent by the connection request with the registered system user information, when the system user information is sent to the information system as a connection request from the external recording medium, and allowing the external recording medium access to the information data on the system within the limits specified by the aforementioned system user information, if the results of the comparison match.

### TECHNICAL FIELD

The present invention relates to an information access control method for preventing the leak of information on a computer system, and more particularly to an information access control system and program for controlling access to data on a computer system and preventing any leak of data to an external recording medium, as well as to an external recording medium used for this purpose.

### BACKGROUND ART

As a consequence of the increasing ubiquity of computers within the workplace in recent years, an ever-larger amount of information is stored on computers on a daily basis. Consequently, the leakage or theft of a company's internal information has become a major problem.

There have also been incidents of individuals either within a company or belonging to an outside corporation using an external recording medium such as an optical disk to carry out unauthorized copying of a company's internal information or making inappropriate use of the same.

A typical example of an information leak might be the use of a network for unauthorized access or copying to an external recording medium. In particular, floppy disks, optical disks, and other similar external recording media are widely used within the corporate workplace. As a result, it is relatively easy for someone to make use of such external recording media in order to copy and leak information stored on a computer system.

In the past, however, companies have tended to allow or refuse access to a given recording medium by relying on a comparison check between a password assigned to the given recording medium, including fixed recording media (hard disks), and a password entered by the user. (See, for example, Patent Documentation 1.)

Because of this, access control has until now been exclusively concerned with controlling access to a given recording medium onto which security-sensitive information has been recorded.

In response to this, it was hypothesized that a higher level of security could be provided by requiring authentication from the external recording medium to which information was to be copied or transmitted.

It might seem that the easiest way to achieve this would be to prevent information outflow by checking for authentication on the external recording medium to which information was to be copied or sent and blocking access to system information for any media without proper authentication.

With this method, however, not only the external recording medium but also the memory device into which it has been inserted would be rendered completely unusable. This in turn would hinder important management operations such as the movement of data during file backup and system maintenance, for example. It would also have the effect of limiting access for all users in a system where a plurality of different users shared access to a single external recording medium.
(Patent documentation 1)
Japanese Patent Application Laid-open No. 2001-23300

### DISCLOSURE OF THE INVENTION

Accordingly, an object of the present invention is to provide an information access control method and program, as well as an external recording medium to be used with these, that will control access to information within a computer system and prevent the leak of data to an external recording medium, without causing any obstruction of routine system operations such as those described above. A first aspect of the information access control method that achieves the objects of the present invention is an information access control method that accesses information data on an information system by using an external recording medium, characterized in that system user information is recorded on the aforementioned external recording medium, and system user information corresponding to the above is registered in advance on the above-mentioned information system; when the aforementioned information system user information is sent to the information system as a connection request from the aforementioned external recording medium, the information system compares the system user information sent as the connection request with the previously registered system user information, and if the results of this comparison match, allows the external recording medium access to the information data on the aforementioned system, within limits specified by the aforementioned system user information.

A second aspect of the information access control method that achieves the objects of the present invention is an information access control method according to the first aspect described above, characterized in that the aforementioned system user information specifies the limits of permissible access to the information data on the aforementioned information system for each of a plurality of users sharing a single external recording medium.

A third aspect of the information access control method that achieves the objects of the present invention is an information access control method for information data on an information system, characterized in that: system user information and an identifier specifying the external recording medium are recorded onto the external recording medium, and user information corresponding to the identifier specifying the aforementioned external recording medium is registered in advance on the aforementioned information system; when the identifier specifying the aforementioned external recording medium and the aforementioned system user information are sent as a connection request to the computer system, the information system checks whether a matching identifier specifying the aforementioned external recording medium exists. If a matching identifier is found to be registered, then it runs a further comparison of the aforementioned system user information with the system user information already registered; if the results of this comparison match, it allows the external recording medium access to the information data on the information system within the limits specified by the aforementioned system user information.

A fourth aspect of the information access control method that achieves the objects of the present invention is characterized in that in the third aspect above, when the identifier specifying the aforementioned external recording medium is found to be registered and if the results of the comparison between the aforementioned system user information and the system user information already registered do not match, then the system only disallows access to the information data on the information system.

A fifth aspect of the information access control method that achieves the objects of the present invention is characterized in that in the first and third aspects described above, a connection history information indicating connections between the information system and the aforementioned external recording medium or media is held on the aforementioned information system, corresponding to the identifiers specifying previously registered external recording media.

A first aspect of the program that controls information access to information data on an information system to achieve the objects of the present invention is characterized in that when system user information is sent to the information system as a connection request from an external recording medium, the program runs a comparison between the system user information sent by the connection request and the system user information already registered on the aforementioned information system, and if the results of this comparison match, allows the external recording medium access to information data on the information system within the limits specified by the aforementioned system user information.

A second aspect of the program that controls information access to information data on an information system to achieve the objects of the present invention is characterized in that in the first aspect above, the aforementioned system user information specifies the limits of access to information data on the aforementioned information system for each of a plurality of users sharing a single external recording medium.

A first aspect of the external recording medium whose access to information data on an information system is controlled in order to achieve the objects of the present invention, is characterized in that system user information is recorded thereon, and when this system user information is sent to the information system as a connection request from the external recording medium, a comparison is carried out within the information system between the system user information sent as the connection request and the system user information already registered on the information system; if the results of this comparison match, then access to information data on the information system is allowed within the limits specified by the aforementioned system user information.

A second aspect of the external recording medium whose access to information data on an information system is controlled in order to achieve the objects of the present invention is characterized in that in the first aspect above, the aforementioned system user information specifies the limits of access to information data on the aforementioned information system for each of a plurality of users sharing a single external recording medium.

The characteristics of the present invention will be made clearer by the description of embodiments and accompanying figures that follow below.

### BRIEF DESCRIPTION OF THE DRAWINGS

FIG. 1 is a block diagram illustrating an embodiment applying the information access control method of the present invention;

FIG. 2 illustrates in outline the sequence of operations within the information access control method of the present invention according to the embodiment shown in FIG. 1;

FIG. 3 shows an example of system user information recorded onto the external recording medium 20;

FIG. 4 shows the processing sequence using the medium log-on information c shown in FIG. 3;

FIG. 5 shows a further example of system user information recorded onto an external recording medium;

FIG. 6 shows the relationship between employees and accessible data, based on the system user information shown in FIG. 5;

FIG. 7 illustrates an example of the operations of system n, using the system user information shown in FIG. 5;

FIG. 8 illustrates an embodiment using a past process history recorded on a computer system;

FIG. 9 illustrates a separate embodiment using a further past process history recorded on a computer system;

FIG. 10 illustrates information recorded on a computer system, showing an example of an application of the present invention;

FIG. 11 illustrates the process, based on the information recorded in FIG. 10;

### BEST MODE FOR CARRYING OUT THE INVENTION

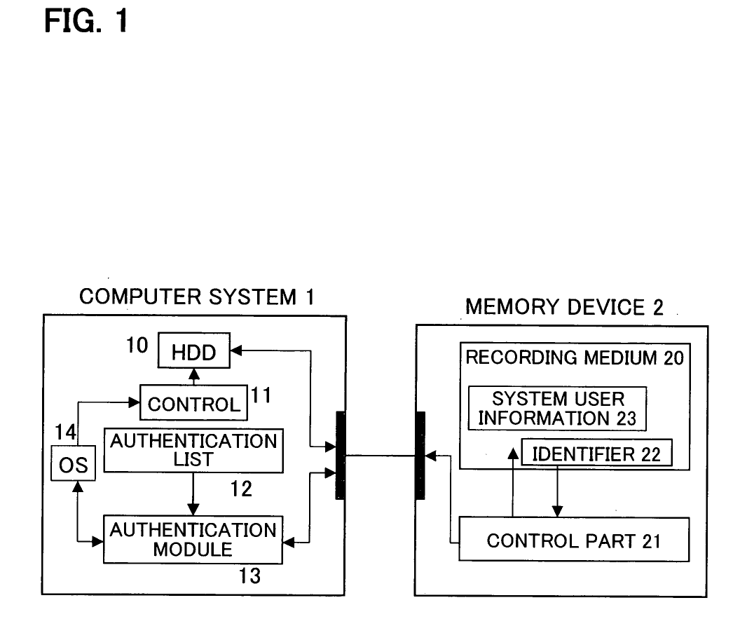

FIG. 1 shows an embodiment of an information control system employing an information access control method according to the present invention. It shows the structure of an information management system that makes it possible to prevent unauthorized copying or leaking of information data recorded to the fixed memory device 10, for example a hard disk device (HDD), within the computer system 1; in other words, to protect data on an information system.

In FIG. 1, the memory device 2 is connected to the computer system 1. The memory device 2 is compatible with the physical specifications of the portable external recording medium 20, and controls the recording and reading of data to and from the external recording medium 20.

It should be noted that the memory device 2 may either be physically independent of computer system 1 and connected thereto as add-on component by a cable or wireless interface, or may be installed as a built-in component within the computer system 1, so that connections between the two are controlled signally by means of a specific command.

In addition to an identifier 22 appended at the time of manufacture or at a later date and specifying the external recording medium 20 itself (medium ID), the system user information 23 provided by the system administrator is also recorded in a given position upon the external recording medium 20. When the identifier 22 and the system user information 23 are recorded onto the external recording medium 20, the system administrator also registers them on the authorization list 12 of the computer system 1 in the same way.

Let it be hypothesized that a user now attempts to use the external recording medium 20 to access information data stored on the computer system 1 or, in more concrete terms, attempts to access information data housed using hard disk device 10 as memory means.

For the purposes of applying the present invention, the external recording medium 20 can be a medium that can be removed from the memory device 2 such as a DVD, CD, MO disk, or flexible disk, or a memory component such as an IC card, a PC card, or a fresh memory device, or may be fixed inside the device as a hard disk (HDD).

Consequently, when a user attempts to access the external recording medium 20 once it has been inserted into the memory device 2, or installed as a fixed component within the memory device 2, the control part 21 reads the identifier 22 and the system user information 23 recorded on the external recording medium 20 and transmits them to the computer system 1.

The computer system 1, meanwhile, is provided with an authentication list 12. As explained above, the system administrator has registered on this list in advance a unique identifier 22 and system user information 23 for any external recording media 20 and system users allowed access.

When the identifier 22 recorded on the external recording medium 20 is transmitted by the control part 21, the computer system 1 carries out a comparison by means of the authentication module 13 to see whether this matches the identifiers previously registered on the authentication list 12.

The authorization module 13 is implemented by a resident software program on the computer system 1, including a device driver. This is provided either by remote transmission or on a storage medium and then installed onto the computer system 1.

A comparison is carried out to check whether the identifier 22 recorded onto the external recording medium 20 matches the identifiers registered in the authentication list 12. If the results of this comparison match, then the external recording medium 20 will be correctly authenticated.

In this case, the user will only be able to copy information data housed within the hard disk device 10 of the compute system 1 according to the limits specified by the system user information 23 recorded on the external recording medium 20.

What is meant by these limits, as specified by the contents of the system user information 23, will be made clear by the embodiments described below, but they may be taken to include specified users, data files within a specified category, or data files saved within a specified period of time, for example.

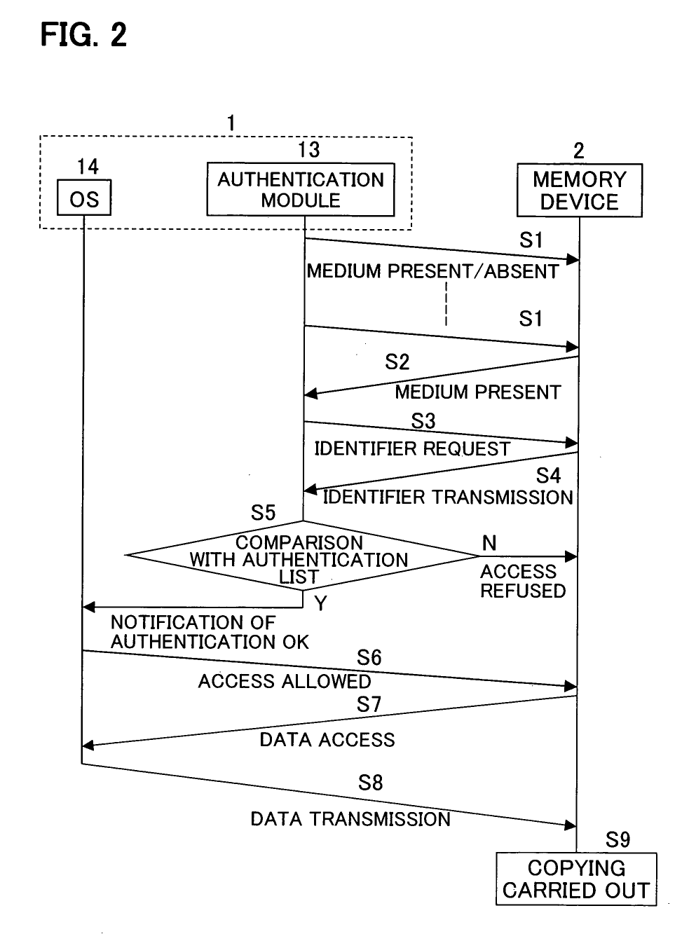

FIG. 2 illustrates in outline the sequence of operations of the information access control method of the present invention according to the embodiment shown in FIG. 1.

When the memory device 2 is connected to the computer system 1, the authentication module 13 within the computer system 1 periodically sends out a prompt to the recording device 2, asking it whether the external recording medium 20 is inserted, and continues to do this until it receives notification that an external recording medium has been inserted (Step S1).

When the external recording medium 20 is inserted, the authentication module 13 detects an external recording medium is present (Step S2). When the authorization module 13 detects that the external recording medium is present, it asks the memory device 2 to transmit the identifier 22 and the system user information 23 recorded on the external recording medium 20 (Step S3). In response to this, the memory device 2 reads the identifier 22 and the system user information 23 from the external recording medium 20 by means of the control part 1, and sends notification of this to the authentication module 13 (step S4).

Next, the authentication module 13 compares the identifier 22 belonging to the external recording medium 20 transmitted by the memory device 2 with the identifiers that have been registered in advance by the system operator on the authentication list 12 on computer system 1 (Step S5)

If the identifier 22 belonging to the external recording medium 20 is not found on the authentication list 12, then access to the computer system 1 using the external recording medium will be refused (step S5, N).

If, during the comparison of the authentication list 12 with the identifiers 22 of the external recording medium 20, the unique identifier 22 that specifies the external recording medium 20, appended as explained above either at the time of manufacture or at a later date, is not found to be registered on the authorization list 12, then the external recording medium 20 will be refused all access.

It should be noted that it is also possible to arrange things so that if there is a match with the identifier 22 specifying the external recording medium 20 but no match with the system user information 23 supplied by the system administrator, then access to information on the computer system 1 is forbidden, but access is allowed for the purpose of sending information recorded on the external recording medium 20 to the computer system 1.

If, on the other hand, the identifier 22 of the external recording medium 20 and the system user information 23 contained in the notification are found to exist on the authentication list 12, then an authentication OK notification takes place in the OS (operating system) 14 of the computer system 1 (Step S5, Y).

By means of this, a notification of access permission is communicated from the OS 14 to the memory device 2 via the authentication module 13 (Step S6). After this, data access takes place as necessary from the memory device 2 via the OS 14 (Step S7).

At this time, data access is limited to the reading of information data within the limits specified by the system user information 23.

The memory device 2 can receive data transmission from the computer system 1 (Step S8) and can record the data to the authenticated external recording medium 20.

Next there follows an explanation of an embodiment employing the information access control method provided by the present invention in order to achieve effective high-security prevention of information leakage.

In this embodiment, the system user information 23 of users who may connect to the computer system 1 is recorded on the external recording medium 20. This system user information 23 is placed in an area of the external recording medium 20 that cannot be accessed by normal commands. Doing this makes it difficult for regular users to consult or alter this information.

In order to realize this, a special command is used for accessing information, which also corresponds to the memory device 2. Security may be further enhanced by making this special command usable only by the system administrator.

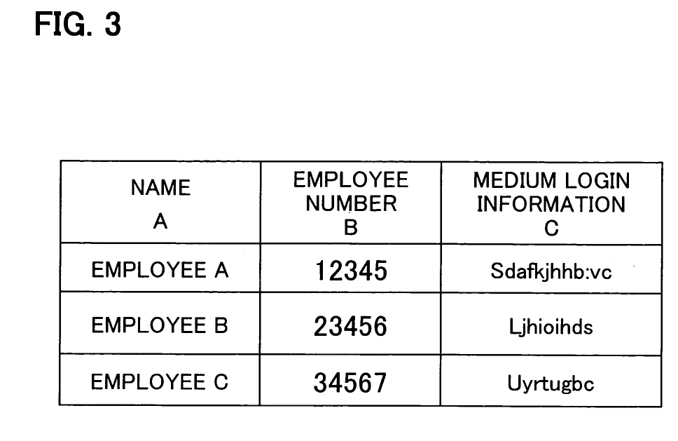

FIG. 3 shows an example of the system user information 23 recorded on the external recording medium 20. In FIG. 3, this system user information 23 comprises the employee's name a, the employee's number b, and the medium log-on information c. The medium log-on information c is a password that a user is required to enter when connecting an external recording medium to the computer system 1.

This medium log-on information c is different for each user, allowing multiple users to share a single external recording medium. It is necessary for the system administrator to register this medium log-on information in advance.

In the example shown in FIG. 3, log-on information corresponding to three employees, A, B, and C, has been registered on the same external recording medium 20.

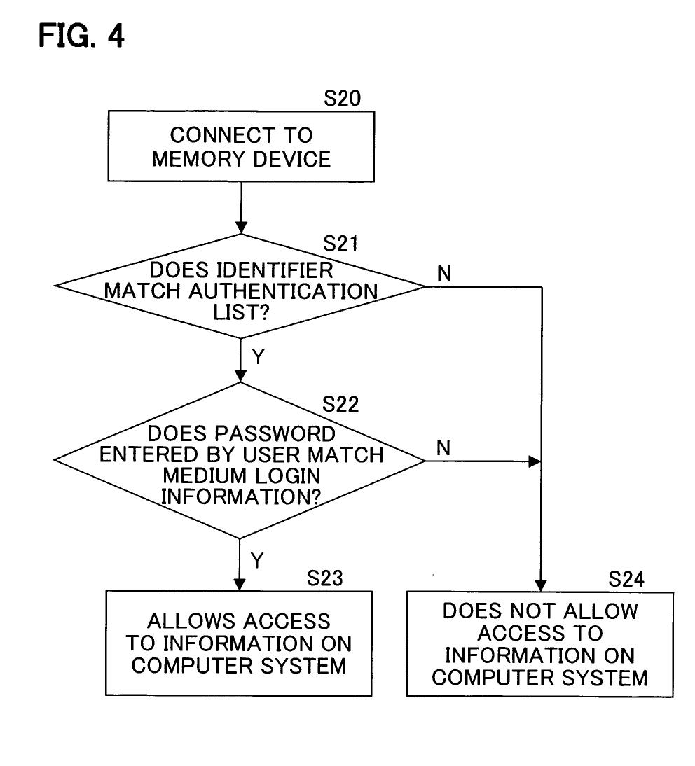

FIG. 4 shows the sequence for processing this log-on information c. In FIG. 4, the recording device 2 is connected to the computer system 1 (Step S20). An identifier is transmitted from memory device 2 to the computer system 1, according to the flow illustrated in FIG. 2, and the authentication module 3 checks whether these identifiers correspond with the external recording media registered on the authentication list 12 (Step S21). If a user connects an external recording medium to the memory device 2 that is not registered on the list, then the identifiers on the medium will not match, and no access to information will be allowed (Step S21, N).

If the identifier does match one found on the authorization list 12 (Step S21, Y), then either the computer system 1 or the memory device 2 will prompt the user to enter the password required when connecting any external recording medium to the computer system 1.

The password entered in response to this by the user is then checked to see whether or not it matches with the medium log-on information c registered on the external recording medium in FIG. 3.

If the user enters the correct password, and inputs the medium log-on information c, then this will match the medium log-on information c registered on the external recording medium (Step S22, Y), and access to the information on the computer system 1 will be permitted (Step S23). In this way, the user is able to copy any necessary information from the computer system 1 onto the external recording medium 20.

Naturally, if the password entered does not match the registered log-on information c in FIG. 3 (Step S22, N), then access to information will be refused (Step S24), and it will not be possible to copy information to an external recording medium.

In another embodiment described below, the information on the system that may be copied is limited in order to increase the degree of protection even further. It does this by restricting the categories of information on the computer system 1 that may be saved to a specified external recording medium 20.

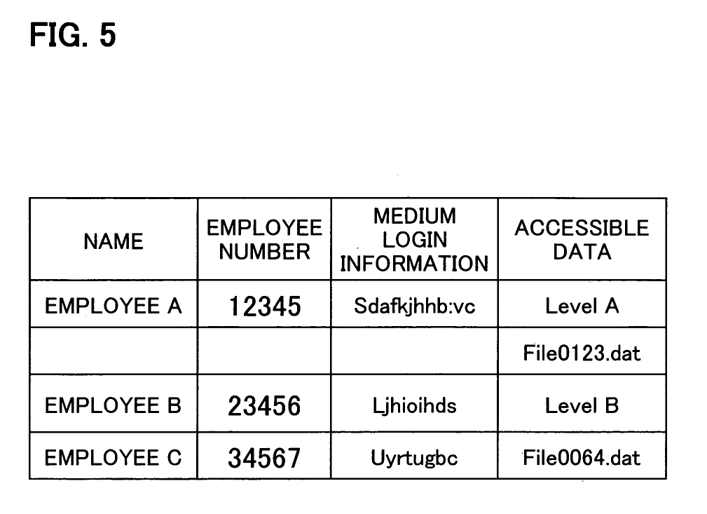

In order to realize this, in addition to the system user information registered on the external recording medium 20 as shown in FIG. 3, the external recording medium 20 is further provided with a clearly marked area for accessible data as shown in FIG. 5. In this example, as well as the name, employee number, and medium log-on information shown in FIG. 3, the accessible data is also described. As in the embodiment described above, the system administrator needs to register this information on the external recording medium 20 in advance before any copying of information from the system takes place. There is no need for this information to be registered on both the external recording medium 20 and the computer system 1.

However, it is possible to register the information on both, and this can be effective for planning and management of data, as well for other day-to-day tasks; in this case it is possible to register information specifying the external recording medium 20 on the computer system 1, making system administration straightforward.

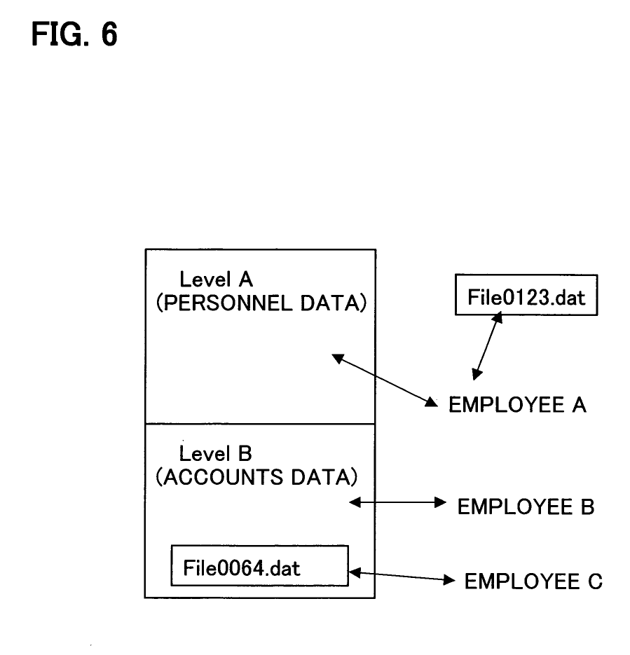

FIG. 6 shows the relationship between each employee and the data that each is able to access, based on the information in FIG. 5. As FIG. 6 illustrates, employee A is able to access (and copy to the external recording medium 20) the group of information classified as belonging to Level A (for example, personnel data) as well as the specific file File0123.dat. Similarly, employee B is allowed to access the group of information classified as Level B (for example, all accounting data), and Employee C can access the file named File0064.dat, which forms one part of the accounts data.

As shown in this example, the data that each user can access can either be individual files or whole groups of data organized by class or level.

When saving accessible data to the external recording medium 20, the data is encoded by log-on information or other means known only to genuine authorized users. In this way, it is possible to control access so that data copied by employees A, B, and C will all be written to the external recording medium 20, but each one will only be able to open data to which they have been allowed access.

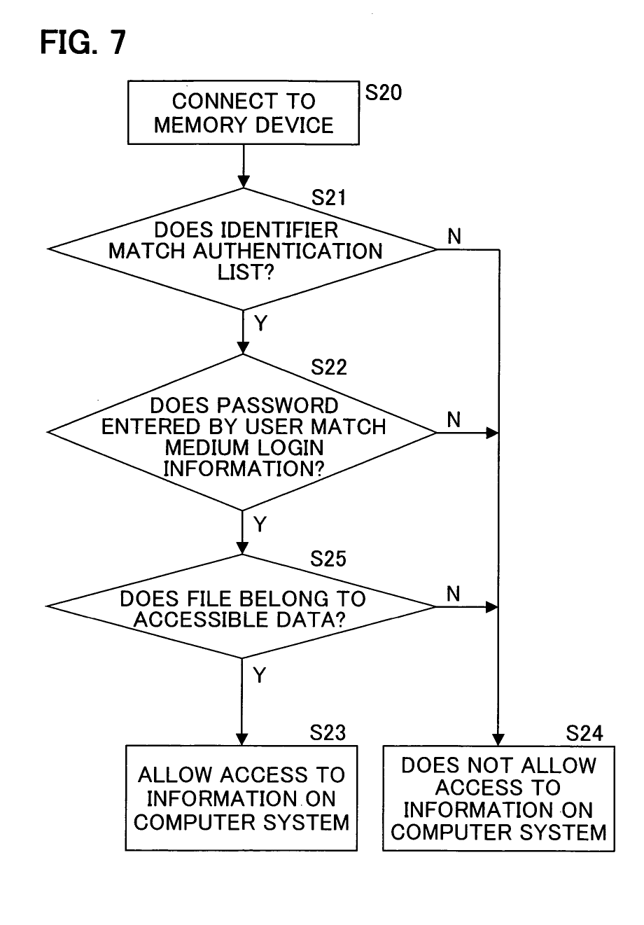

FIG. 7 shows the process until access is established, based on the information shown in FIG. 6. In FIG. 7, the process is similar to that shown in FIG. 4 as far as steps S20-S22. Then, in Step 22, if the password entered by the user matches the medium log-on information (Step S22, Y), a check is run to see whether the information to be accessed matches the registered accessible data as shown in FIG. 5 (Step S25).

If it is accessible data, then access is granted allowed, Step S23); if it is not, then access is denied (Step S24).

The embodiments described above make it possible to limit the media to which information can be copied and/or moved, by registering a unique identifier and user information on the external recording medium 20, thus preventing any leaking of information.

The following application may be added as a further example of an information access control method having the characteristics of the present invention as described above. By means of this, it is possible to exert even greater control over unauthorized access to information.

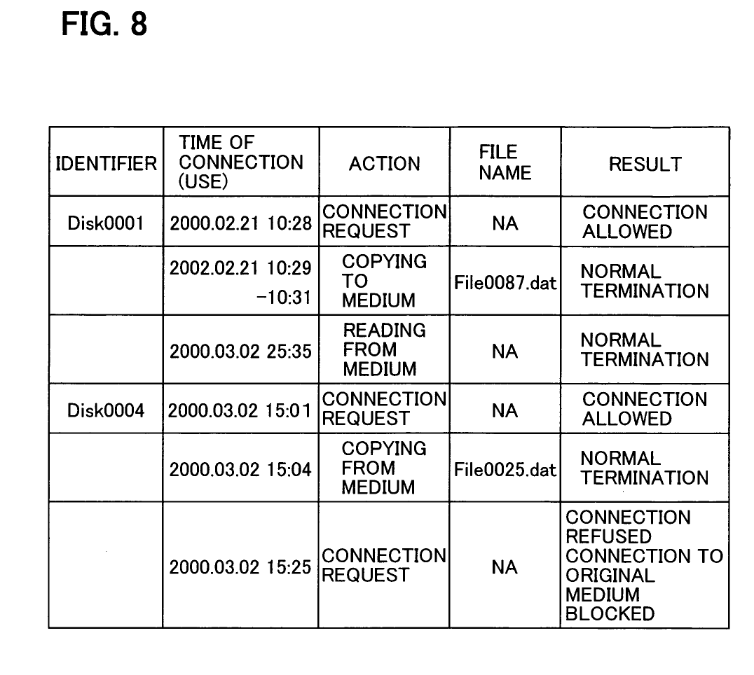

FIG. 8 shows an example of information registered and saved onto the authentication list 12 of the computer system 1. In this example, the connection history of the external recording media 20 has been saved onto the authentication list 12, corresponding to the identifiers of the external recording media 20 registered in advance by the system administrator as acceptable for use on the system.

By looking back over this list, it is possible to consult the connection history of each of the external recording media 20.

In FIG. 8, in response to a connection request (time of request: Mar. 2, 2000 15:25) from an external recording medium having the identifier Disk0004, suspected of being a duplicate recording medium, connection is refused and the connection of the original external recording medium already connected is blocked (see the column labeled as Result).

For the external recording medium with the identifier Disk0001, the record shows a file with the name File0087.dat as having been copied from the information system. This history of connection processes for each recording medium makes it possible to look back over the record to find the time and data (filename) involved for each occasion on which there was an outflow of information.

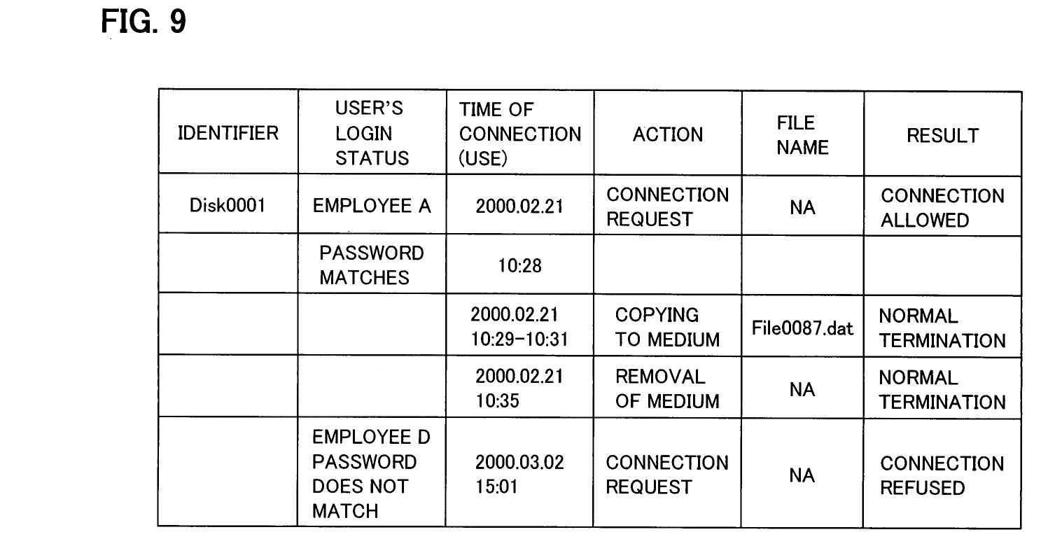

FIG. 9 shows a further embodiment, in which a history showing users' login status is added to the authentication list 12 of the computer system 1. Employee A, for example, has used the external recording medium 20 having the identifier Disk0001. In this case, Employee A has been registered in advance by the system administrator as a user of the external recording medium 20, and because the user correctly entered the user password (that is, correctly inputted the medium log-on information c) at (10:28), access to system information was permitted, and it is recorded on the list that file File0087.dat was copied to the external recording medium 20.

However, because Employee D is not registered as a user of the external recording medium having the identifier Disk0001, the password entered by the user did not match the medium log-on information, and consequently the connection of the external recording medium 20 to information maintained on the computer system 1 was refused, and no copying of information was possible, thus preventing any outflow of information.

In a further embodiment, as well as the identifier I of any external recording media registered on the authentication list 12, a flag II is installed that indicates whether an external recording medium is currently connected to the computer system 1—that is, whether any external recording medium 20 has been allowed access to the data saved on the computer system 1 and whether it is already connected.

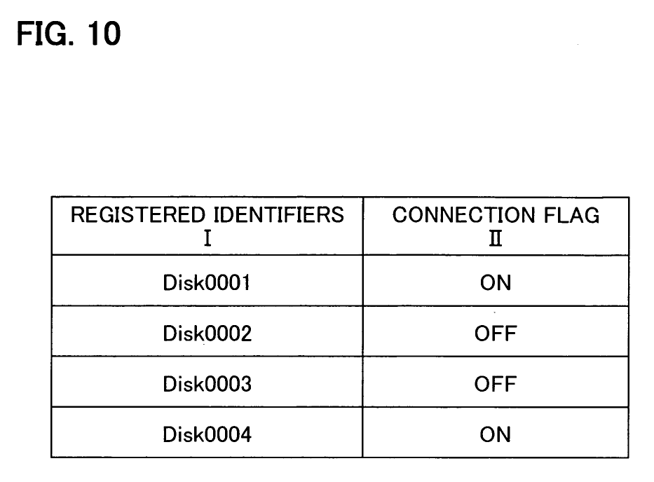

FIG. 10 illustrates this embodiment. In this example, the external recording media 20 having the identifiers Disk0001 and Disk0004 have been inserted into the recording device 2 and are currently connected to the computer system 1 (the connection flag II is ON).

Confirming the status of the connection flag II in this way makes it easy to detect a duplicate connection request from an external recording medium having the same identifier as the one already connected.

In this case, it is possible to confirm that either the external recording medium already connected or the external recording medium that has just sent a new connection request has gained unauthorized access to the identifier registered on the genuine external recording medium, and duplicated it.

In this situation, by taking the necessary steps, including controlling (stopping) the access of the recording medium that connected first, it is possible to keep to the leaking of information to an unauthorized external recording medium a minimum.

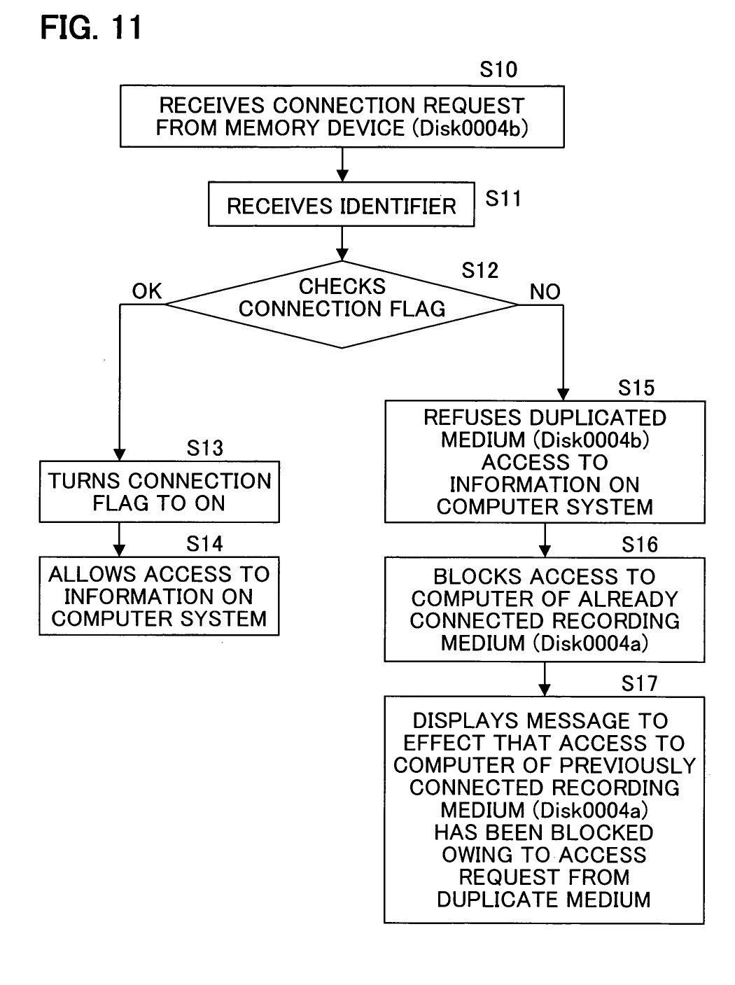

FIG. 11 shows the sequence of operations in a case where the external recording medium 20 having the identifier Disk0004 has been duplicated. To differentiate the two here, the external recording medium that was connected first has been given the identifier Disk0004a, while the duplicated disk that sent out a connection request later on has been given the identifier Disk0004b in FIG. 11 and the explanation thereof that follows.

In FIG. 11, when it is detected that the memory device 2 has an external recording medium (See FIG. 11, Step S2), that is, when it receives a connection request (Step S10) from the external recording medium (identifier Disk0004b), the identifier Disk0004b is sent to authentication module 3 of the computer system 1 (Step S11).

The authentication module 3 verifies that the identifier Disk0004b has been registered on the authentication list 12, and at the same time consults the connection flag II (Step S12).

At this stage, if the connection flag II is not showing currently connected (Step S12, OK), then it changes the setting of the connection flag II from OFF to ON (Step S13), and allows access to information on the computer system 1 (Step S14). Based on this, notification that access permission has been granted is transmitted to the memory device 2 by the OS, as explained in FIG. 2 (FIG. 2, Step S6).

However, if during Step S12 the connection flag II corresponding to Identifier Disk0004 is already in the ON setting (Step S12, NO), then the duplicated external recording medium (Disk0004b) will be denied access to the information on the computer system 1 (Step S15, FIG. 11: Step S5, N).

In the present embodiment, the external recording medium already connected (Disk0004a) if blocked from accessing the computer by means of the authentication module 3 of the computer system 1 (Step S16). It is also possible to show either on the display of the computer system 1 or on the recording device 2 a message indicating that, ‘Owing to an access request from a duplicate external recording medium, the access to the computer system of the external recording medium already connected (Disk0004a) has been blocked’ (Step S17).

### INDUSTRIAL APPLICABILITY

As described in the explanations and diagrams above, the present invention limits access to specified information on a computer system based on the authentication of external recording media, so that authenticated external recording media can be used on the system, providing a flexible system environment for data backup and maintenance.

In addition to this, access to the computer system by any unauthenticated external recording media is blocked, preventing any leaking of information from the system.

1. An information access control method, which uses an external recording medium to access information data on an information system, the information access control method comprising the steps of:
wherein system user information is recorded on the external recording medium, and corresponding system user information is registered in advance on the information system,
comparing the system user information sent as a connection request with the already registered system user information, when the system user information is sent as the connection request by the external recording medium to the information system; and
allowing the external recording medium access to the information data on the system within the limits specified by the system user information, if the results of the comparison match.

2. The access control method according to claim 1, wherein the system user information specifies the limits of access to the information data on the information system for each one of a plurality of users sharing a single external recording medium.

3. The information access control method for information data on an information system, wherein
an identifier specifying an external recording medium and system user information are recorded onto the external recording medium, and the system user information corresponding with the identifier specifying the external recording medium is registered in advance on the information system,
further comprising the steps of, checking whether the identifier specifying the external recording medium already been registered, when the identifier specifying the external recording medium and the system user information are sent as a connection request to the computer system;
comparing the system user information with registered system user information, when the identifier is found to be registered; and
allowing the external recording medium access to the information data on the information system within the limits specified by the system user information if the results of the comparison match.

4. The information access control method according to claim 3, further comprising the step of disallowing only access to the information data on the information system, when the identifier specifying the external recording medium is found to be registered and if the results of the comparison between the system user information and the system user information already registered do not match.

5. The information access control method according to claim 1 or 3, further comprising the step of holding connection history information indicating previous connections between the external recording medium and the information system, as corresponding to the registered identifiers of any external recording media.

6. An access control program for controlling the information access to information data on an information system,
wherein when system user information is sent to an information system as a connection request from an external recording medium, the program causes the information system to compare the system user information sent by the connection request with system user information already registered on the system; and
if the results of the comparison match, the program allows the external recording medium access to the information data on the information system within the limits specified by the system user information.

7. The access control program according to claim 6, wherein the system user information specifies the limits of access to the information data on the information system for each one of a plurality of users sharing a single external recording medium.

8. An external recording medium whose access to information data on an information system is controlled, recording system user information thereon,
herein when the system user information is sent to the information system as a connection request by the external recording medium, a comparison is carried out within the information system between the system user information sent by the connection request and the system user information registered in advance on the information system; and
if the results of the comparison match, access is allowed to the information data on the information system within the limits specified by the system user information.

9. The external recording medium according to claim 8, wherein the system user information specifies the limits of access to the information data on the information system for each of a plurality of users sharing a single external recording medium.
